(19) United States
(12) Patent Application Publication
(10) Pub. No.: US 2023/0019537 A1
(43) Pub. Date: Jan. 19, 2023

(54) Fueling Mat for Aircraft

(71) Applicant: RPS Corporation, Racine, WI (US)

(72) Inventor: Sean K. Goff, Breckenridge, CO (US)

(21) Appl. No.: 17/379,585

(22) Filed: Jul. 19, 2021

(51) Int. Cl. B64F 1/28; B64D 37/32; B64F 1/00

(52) U.S. Cl. CPC B64F 1/28; B64D 37/32; B64F 1/005

(57) ABSTRACT

A fueling mat includes a main body configured as a sheet. The main body includes an opening defined in the main body and a plurality of tabs. The opening defines an outer perimeter and the tabs extend inwardly from the outer perimeter. The tabs are configured to flex out of the opening. With this structure, the tabs can protect the region of a fuel port from damage, whether or paint or structural, during fueling and further can help cover the opened fuel port, at least fractionally, before a fuel nozzle is inserted.

### CROSS-REFERENCE TO RELATED APPLICATION

Not applicable.

### STATEMENT OF FEDERALLY SPONSORED RESEARCH OR DEVELOPMENT

Not applicable.

### BACKGROUND

This invention relates generally to mats for use in servicing equipment and, in particular, to mats for protecting surfaces of an aircraft from scratching, chipping, denting and other damage during fueling as well as for at least fractionally covering the fuel opening when the fuel cap is removed.

Aircraft, and more specifically, small or personal aircraft, typically include a fuel port formed in a top surface of a wing. The fuel port provides access to a fuel tank disposed within the wing. When fueling is required, a cap can be removed from the fuel port to allow a fuel nozzle to be inserted into the fuel port to deliver fuel. The cap may include an O-ring that engages with an O-ring seat surrounding the fuel port to create a vapor-tight seal. In some cases, a cap may be removed by hand, but the cap may also require a tool be used to remove the cap.

Over the life of the aircraft, the fuel port and other wing surfaces surrounding the fuel port can become damaged during fueling. In particular, a wing is made of a thin skin, typically an aluminum sheet, which is coupled to an internal frame. Additionally, the skin may be covered by paint or other surface finishes to help protect the skin. Over time, the skin, paint, and/or fuel port may become damaged due to the fuel nozzle or other tools contacting the skin and/or fuel port.

For example, a nozzle may contact an edge of a fuel port when being inserted into the fuel port, which can cause the paint to scratch or chip, and which can dent the skin along an O-ring seat. Similar damage may also occur as a result of tools or other objects being placed on the wing during service. Moreover, the paint may experience chemical damage due to fuel or other chemicals (e.g., fuel additives) dripping or otherwise spilling onto the skin, which may eventually lead to further corrosion and/or oxidation of the underlying aluminum.

Fuel mats are used to attempt to mitigate damage to the skin. See, for example, U.S. Pat. No. 5,240,759. Such fuel mats are generally made from a flexible, non-slip material that is placed onto and conforms to the surface of the wing. The fuel mat includes an opening that is aligned over a fuel port to allow a nozzle to be inserted into the fuel port to deliver fuel to a fuel tank.

### SUMMARY

In the design of such fueling mats, an opening is generally sized to allow the fueling mat to accommodate a variety of nozzle shapes and to surround a variety of different sized fuel ports. To do so, the openings tend to be oversized, which commonly results in the skin surrounding the fuel port being exposed to both physical and chemical damage. Thus while, known fuel mats may protect the skin of an aircraft in some cases, damage in and around the fuel port is still possible.

Such damage to the fuel port may be especially harmful as it may prevent a cap from properly sealing a fuel tank. For example, as described above, the skin surrounding a fuel port may define an O-ring seat that is configured to allow a cap to form a vapor-tight seal between the cap and the skin to seal off a fuel tank. Current designs of fuel mats can leave the O-ring seat exposed and unprotected during fueling (i.e., uncovered), which may cause the O-ring seat to become dented or cause the paint on the O-ring set to become chipped. Such damage results in an uneven surface that can prevent the cap from creating the necessary vapor-tight seal to keep liquid and vaporized fuel in the fuel tank and, more critically, can create a condition in which water could ingress into the fuel tank if the aircraft is left to sit outside during precipitation for long durations of time. Additionally, because of the close proximity to the fuel tank, the O-ring seat commonly comes into contact with fuel and other corrosive chemicals, making damage to the paint in this area especially harmful with regard to causing corrosion of the skin. Such damage is also time-consuming and costly to repair.

Beyond this, during use, the opening on the mat typical does not cover the fuel port after the fuel cap has been removed. This can create some potential for ingress of environmental objects (moisture, small debris, and so forth) into the tank before the fueling begins.

Disclosed herein is an improved fueling mat having an improved opening with a plurality of inwardly extending tabs or fingers with slots therebetween. The tabs are configured to extend at least partially over a fuel port when the mat is placed on a surface of an aircraft during fueling. The tabs can be sized and shaped to extend over a variety of different fuel ports having different sizes and/or shapes, and a variety of nozzles having different sizes and/or shapes.

Additionally, the tabs are flexible to allow the tabs to bend and/or flex to accommodate a fuel nozzle being inserted through the opening and into the fuel port. More specifically, the nozzle may contact at least one of the tabs to bend the tab toward the fuel port. In this way, the tab may be bent into contact with an O-ring seat or other surface surrounding the fuel port to act as a protective barrier between the O-ring seat or other surrounding surface and the fuel nozzle. Additionally, the tab may be bent so as to extend partially into the fuel port to protect an inner perimeter of the fuel port and protect any surrounding paint.

According to one aspect, a fueling mat includes a main body configured as a sheet. The main body includes an opening formed in the main body and a plurality of tabs. The opening defines an outer perimeter and the tabs extend inwardly from the outer perimeter. The tabs are configured to flex out of the opening.

In some forms, the tabs may be integrally formed with the main body.

In some forms, the main body may have a top surface and a bottom surface opposite the top surface. The opening may extend between the top surface and the bottom surface. Additionally, the opening may be centered or the opening may not be centered with respect to the top surface.

In some forms, the plurality of tabs may be defined by a corresponding plurality of slots.

In some forms, the outer perimeter of the opening may have a round shape and the plurality of tabs may extend radially inward from the outer perimeter. Each of the plurality of tabs is configured to flex axially (or in the direction of the thickness) and independently out of the opening. However, the opening (and, more particularly, the outer perimeter of the opening) could be any geometry including, but not limited to, circular, elliptical, round, square, rectangular, trapezoidal, polygonal, and so forth.

In some forms, the opening may further define an inner perimeter and the tabs may extend (or project) from the outer perimeter to the inner perimeter of the opening. The plurality of tabs may flex to allow an object, such as a fueling nozzle having a perimeter that is larger than the inner perimeter of the opening (but smaller than the outer perimeter of the opening) to pass through the opening.

According to another aspect, a servicing mat for protecting a piece of equipment is provided. The servicing mat includes a main body configured as a sheet and an opening formed in the main body. The opening includes a plurality of outwardly extending slots that define a corresponding plurality of tabs. Each of the plurality of tabs may be configured to independently flex out of the opening.

In some forms, the main body may define a top surface opposite a bottom surface. The bottom surface can be configured to contact the piece of equipment.

In some forms, the opening may be configured to surround a hole in the piece of equipment and at least one of the plurality of tabs can flex toward the hole. One or more of the tabs may flex so that the tab(s) is/are at least partially disposed within the hole when flexed.

In some forms, the opening may have an inner perimeter having a round shape. The plurality of slots may extend radially outward from the inner perimeter.

According to yet another aspect, a fueling mat for use in fueling an aircraft is provided in which the aircraft includes a fuel port configured to receive a fuel nozzle. The fueling mat includes a main body configured as a sheet having a top surface opposite a bottom surface with the bottom surface being configured to contact the aircraft during fueling. The fueling mat also includes an opening extending between the top surface and the bottom surface and further includes a plurality of tabs. The opening defines an outer perimeter and the tabs extend inwardly from that outer perimeter. The tabs are configured to flex beyond the bottom surface.

In some forms, the main body may be placed over the fuel port (e.g., during fueling) so that the outer perimeter of the opening surrounds the fuel port. In this way, the fuel nozzle can be inserted into both of the opening and the fuel port. In some cases, the nozzle may contact at least one of the tabs to flex the tab(s) beyond the bottom surface. The tab(s) may be flexed to be disposed at least partially into the fuel port. In this way, at least one of the tabs may be disposed between the nozzle and the aircraft to protect the aircraft. More specifically, the tab(s) extending into the fuel port includes contacting an outer periphery of the fuel port.

In some forms, the opening may have a round outer perimeter and the plurality of tabs extend radially inward from the outer perimeter.

In some forms, the main body may be made of a flexible material to allow the main body to conform to the shape of the aircraft. Furthermore, the plurality of tabs can be integrally formed with the main body.

According to another aspect, a method of using a fueling mat as described above and herein includes the steps of placing the mat on a surface of the aircraft so that the opening surrounds the fuel port and inserting the fuel nozzle through the opening and the fuel port so that the fuel nozzle contacts one or more of the tabs. The fuel nozzle contacting the tab(s) causes the tab(s) to flex beyond the bottom surface. In this way, the tab(s) may be disposed between the nozzle and the aircraft to protect the aircraft.

These and still other advantages of the invention will be apparent from the detailed description and drawings. What follows is merely a description of some preferred embodiments of the present invention. To assess the full scope of the invention, the claims should be looked to as these preferred embodiments are not intended to be the only embodiments within the scope of the claims.

### BRIEF DESCRIPTION OF THE DRAWINGS

FIG. 1 is a top plan view of a fueling mat having an improved opening with a plurality of tabs.

FIG. 2 is a top front left perspective view of the fueling mat of FIG. 1.

FIG. 3A is a partial side schematic view of the fueling mat of FIG. 1 placed on a wing of an aircraft in a pre-fueling configuration, with a section of the wing removed to better illustrate a fuel port and a fuel tank.

FIG. 3B is a partial bottom schematic view of the fueling mat of FIG. 1 placed on a wing of an aircraft in the pre-fueling configuration similar to that shown in FIG. 3A.

FIG. 3C is a partial perspective schematic view of the fueling mat of FIG. 1 in the pre-fueling configuration from FIGS. 3A and 3B, but with the wing removed.

FIG. 4A is a partial side schematic view of the fueling mat of FIG. 1 placed on a wing of an aircraft in a partial-insertion configuration, with a section of the wing removed to better illustrate a fuel port and a fuel tank.

FIG. 4B is a partial bottom schematic view of the fueling mat of FIG. 1 placed on a wing of an aircraft in the partial-insertion configuration.

FIG. 4C is a partial perspective schematic view of the fueling mat of FIG. 1 in the partial-insertion configuration, with the wing removed.

FIG. 5A is a partial side schematic view of the fueling mat of FIG. 1 placed on a wing of an aircraft in a full-insertion configuration, with a section of the wing removed to better illustrate a fuel port and a fuel tank.

FIG. 5B is a partial bottom schematic view of the fueling mat of FIG. 1 placed on a wing of an aircraft in the full-insertion configuration.

FIG. 5C is a partial perspective schematic view of the fueling mat of FIG. 1 in the full-insertion configuration, with the wing removed.

FIG. 6 is a top plan view of an alternative profile for an opening in which some of the tabs have been shortened to provide a possible line of sight into the tank.

### DETAILED DESCRIPTION OF THE PREFERRED EMBODIMENTS

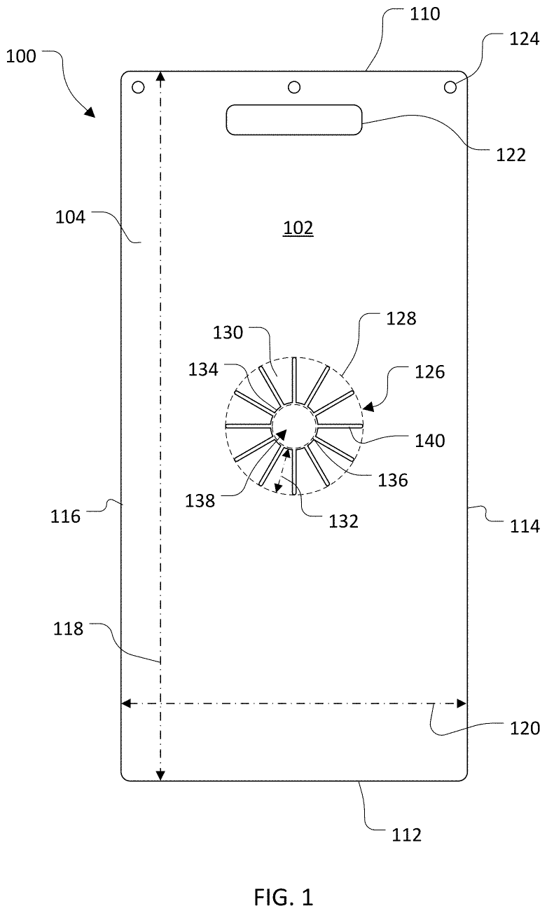

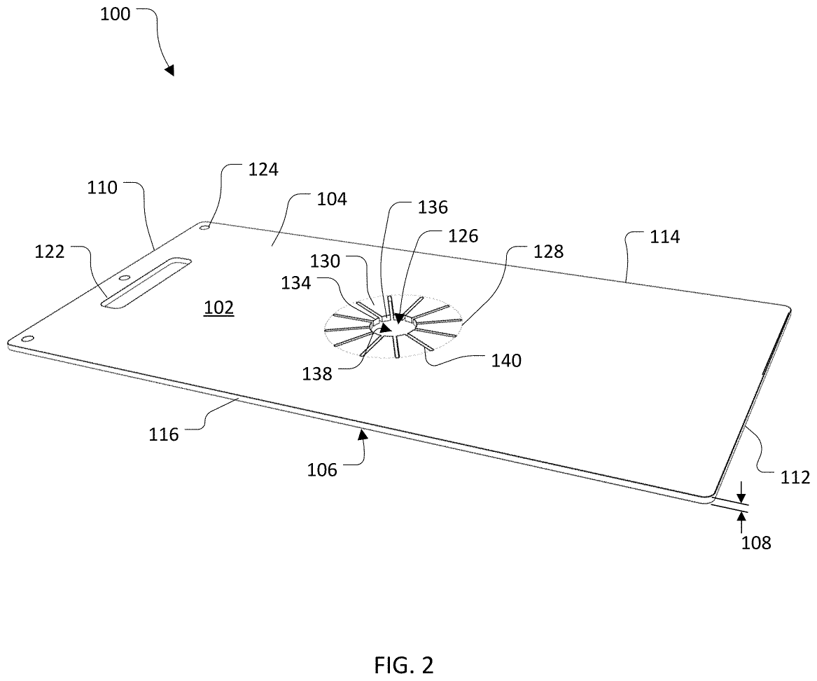

FIGS. 1-2 illustrate an embodiment of a mat 100 according to aspects of this disclosure. As shown, the mat 100 is configured as a fueling mat that can be placed over a fuel port of an aircraft to protect the fuel port and/or a surrounding surface of the aircraft during fueling. While the primary use of the mat 100 is contemplated as being for aircraft refueling, the mat 100 may also be used more generally for servicing a piece of equipment. For example, the mat 100 may be placed over a hole in a piece of equipment to allow tools or other objects to be passed through the hole in the equipment while also protecting the hole and/or a surface of the equipment surrounding the hole.

As illustrated, the mat 100 includes a main body 102 configured as a sheet having a top surface 104 opposite a bottom surface 106 (which although not specifically illustrated, has the same appearance as the top surfaces 106). The main body 102 may be stamped/cut from a blank or molded, and is generally made from a flexible and resilient material that can conform to a surface of a piece of equipment, such as the wing of an aircraft. Some non-limiting examples of materials include rubber, urethane, silicone, or other elastomeric compounds.

In some cases the material may be chosen to provide a non-slip or tractive characteristic to help prevent or resist the mat 100 from slipping off of a support surface such as the wing of the aircraft. Additionally, the main body 102 can be made from a material that is specially adapted to be resistant to specific chemicals, for example, aircraft or jet fuel. Moreover, the main body 102 may be made from materials having one or more different colors. Such coloration can be used to indicate to a user that a mat 100 is adapted for use in a specific application. For example, the mat 100 may have a yellow coloration that may indicate that the mat is chemically resistant to jet fuel. Similarly, the mat 100 may be clear to allow a user to see through the mat 100. Particularly if the transparency is robust, the ability to see through the mat 100 can be beneficial to determining what the fuel level is within the tank of the wing.

The top surface 104 and the bottom surface 106 are separated from one another to define a thickness 108 of the main body 102. The main body 102 may be substantially flat in an un-stressed and un-flexed state such that a local thickness of the main body 102 may vary within ±10% of an average thickness of the main body 102. Although not illustrated, the top surface 104 may include recesses and/or protrusions (not shown), which may individually vary beyond 10% of the average thickness of the main body 102. The recesses and/or protrusions may be configured to retain and/or support equipment or other objects used during servicing, for example, tools, a cap for a fuel port, bottles of fuel additive, a fuel nozzle, and so forth. Such recesses and/or protrusions may also be used as indicia, which may be used for branding to be source identifying or to provide an indication to a user.

Still referring to FIGS. 1 and 2, the main body 102 is shown having rectangular shaped outer perimeter with rounded corners. More specifically, the mat 100 defines a first side 110 that is parallel and opposite a second side 112, and a third side 114 that is parallel and opposite a fourth side 116. Each of the third side 114 and the fourth side 116 extend perpendicularly between the first side 110 and the second side 112. In this way, the main body 102 defines a length 118 of the mat 100 that extends between the first side 110 and the second side, and a width 120 of the mat 100 that extends between the third side 114 and the fourth side 116. The length 118 is greater than the width 120.

Although the illustrated mat is generally rectangular, in other embodiments, a main body may have any other polygonal or non-polygonal shape. Where the main body has a different shape, a length may be a largest dimension between two opposing sides of a rectangle circumscribing an outer perimeter of the main body (for example, a first side and a second side similar to the first side 110 and the second side 112, respectively) and a width a dimension between the remaining opposing sides (for example, a third side and a fourth side similar to the third side 114 and the fourth side 116, respectively). The length may be greater than or equal to the width.

In some cases, a main body of a mat can optionally include hanging elements and/or a handle. For example, the mat 100 can include a handle 122 to allow a user to more easily carry and manipulate the mat 100. Here, the handle 122 is a rectangular hole disposed adjacent the first side 110. In other embodiments, the handle 122 may be of a different size or shape. Additionally, the handle 122 may be provided anywhere along the main body 102, and multiple handles may be provided. Furthermore, a handle may be provided as a separate element that is coupled with the main body 102.

As shown, the mat 100 also includes a plurality of hanging elements configured as a plurality through holes 124 formed along the first side 110 of the main body 102. The plurality of through holes 124 are configured to receive hook or other hanging structure (not shown) to allow the mat 100 to be hung when not in use. In other embodiments, the plurality of through holes 124 may be of a different size or shape. Additionally, more or less holes may be provided and they may be positioned anywhere along the main body 102. Furthermore, it is contemplated that other structures or features may instead, or additionally, be provided to allow the mat 100 to be hung including, for example, the handle.

Most pertinent to this disclosure, the mat 100 further includes an opening 126 disposed in the main body 102 to allow an object to pass through the main body 102, for example, a portion of fuel nozzle. The opening 126 is a through hole that extends between the top surface 104 and the bottom surface 106. More specifically, the opening 126 can extend perpendicularly between each of the top surface 104 and the bottom surface 106. Put another way, the opening 126 extends along the thickness 108 of the main body 102 which generally corresponds with an axial direction of the opening 126. Furthermore, the opening 126 may be disposed anywhere along the top surface 104 of the main body 102, but is preferably disposed in the center of the top surface 104.

The opening 126 defines an outer perimeter 128 (shown by a dashed line in FIGS. 1 and 2, although in actuality the dashed lines cannot be seen and are only annotated in the figures for purposes of description). The outer perimeter 128 defines a maximum size of the opening 126. That is, a maximum width and a maximum cross-sectional area of the opening 126, said cross sectional area taken perpendicular to the thickness 108 of the main body 102. In this case, the outer perimeter 128 has a circular shape, but it may also have any other shape, for example, a round, ellipsoidal, or rectangular shape. However, the opening (and, more particularly, the outer perimeter of the opening) could be any one of a number of geometries including, but not limited to, circular, elliptical, round, square, rectangular, trapezoidal, polygonal, and so forth.

With continued reference to FIGS. 1 and 2, a plurality of tabs 130 extends inwardly (i.e., radially inward) from the outer perimeter 128 of the opening 126. As shown, the tabs 130 are integrally formed with the main body 102; however, the tabs 130 may also be separate structures that are coupled with the main body 102.

Each of the tabs 130 extends along a tab length 132 (for example, a length along a radial line of the opening 126) and terminates a respective distal end 134. In other embodiments, the tab length 132 can be longer or shorter than that illustrated. Additionally, while each of the tabs 130 is shown having an equal tab length 132, this may not always be the case. Together, the distal ends 134 define an inner perimeter 136 of the opening 126 such that the tabs 130 extend between the outer perimeter 128 and the inner perimeter 136 of the opening 126. As shown, the inner perimeter 136 has a circular shape corresponding with the outer perimeter 128, but it may also have any other shape, for example, an ellipsoidal or any other polygonal or non-polygonal shape. The inner perimeter 136 may define an effective cross-sectional area of the opening 126 when the tabs 130 are not flexed. It will be appreciated that, as illustrated, the inner perimeter 136 is offset slightly inward from the tips of the tabs 130 for purposes of clarity in illustration but, in actuality, will coincide with the tips of the tabs 130.

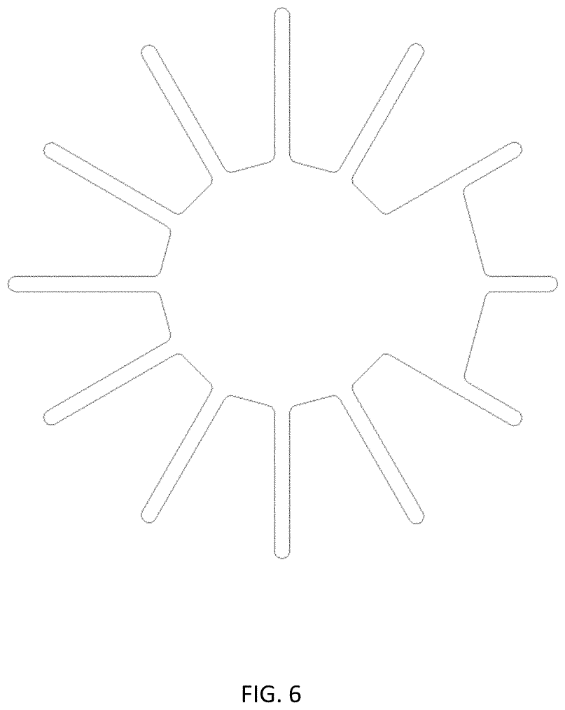

Furthermore, the tabs 130 are shown being equally angularly spaced around the opening 126; however, the tabs 130 may also be unequally spaced. Put another way, the opening 126 may include an inner portion 138 defined by the inner perimeter 136 and a plurality of outwardly (i.e., radially) extending slots 140 that separate the corresponding plurality of tabs 130. Here, the slots 140 are configured as linear slots that extend radially from the inner perimeter 136 to the outer perimeter 128 to define the plurality of tabs 130. The size and shape of each of the plurality of slots 140 may vary in a manner that corresponds with the size and shape of the plurality of tabs 130. For example, wider slots correspond with thinner tabs, longer slots correspond with longer tabs, and vice versa. Still further the relative angular orientations of the slots and tabs could be varied and there may even be angular gaps between tabs which can help to provide a “window” though the opening to see inside the fuel tank. For example, and with forward reference to FIG. 6, an alternative profile of an opening is illustrated in which two of the tabs on the right side have been truncated to approximately half of their radial distance to provide a viewing window in the angular space between the two adjacent full length tabs and between the tips of the shorter tabs and wherever the nozzle ends up being position. In this way, even after a nozzle has been inserted and most of the tabs have flexed downward or into partial contact with the nozzle, the window created by the short tabs can enable the person fueling to have a line of sight into the interior volume of the tank be able to see the fuel level within the tank so as to prevent overfilling of the tank.

The tabs 130 are configured as flexible tabs that can flex (i.e., bend along the tab length 132 and/or slightly twist) out of the opening 126 to vary the effective cross-sectional area of the opening 126. That is, each of the tabs 130 can independently flex between an un-flexed configuration and a flexed configuration. The un-flexed configuration is defined as the natural position of each of the tabs 130 where an external object (for example, a fuel nozzle) does not act on (that is, contact) the tabs 130 to apply a force to the tabs 130 tab in order to flex the tab 130. It is appreciated that, in the un-flexed configuration, the respective distal ends 134 of the tabs 130 may be disposed appreciably beyond either of the bottom surface 106 or the top surface 104 due to the effect of gravity acting on the tabs 130. For example, the weight of the tabs 130 alone may cause the distal ends of the tabs 130 to only minimally droop so that the distal ends 134 are disposed within 10% of the thickness of the main body 102 beyond the bottom surface 106 at most. The extent of said droop may vary depending on, for example, the material properties of the tabs 130 and the size of the tabs 130. Furthermore, the extent of said droop may vary depending on the orientation of the mat.

The tabs 130 assume the flexed configuration when an external object contacts the tabs 130 to move the tabs 130 away from their natural, un-flexed configuration. For example, an object (e.g., a fuel nozzle) may be inserted through the opening 126 which may cause at least a portion of the tabs 130 to flex further outward (for example, in an axial direction or thickness) of the opening 126 to move the respective distal ends 134 even further beyond the bottom surface 106. In doing so, the respective distal ends 134 also move radially outward (i.e., towards the outer perimeter 128). Thus, the flexing of the tabs 130 effectively enlarges the inner perimeter 136 of the opening 126 to increase the effective cross-sectional area of the opening 126 and allow the object (typically the fuel nozzle) to be passed through the opening 126.

The tabs 130 may only flex to the extent necessary to allow the object to pass through the opening 126. More specifically, an object with a cross-sectional area that is less than the effective cross-sectional area defined by the inner perimeter 136 may pass through the opening without contacting or flexing any of the tabs 130. Conversely, an object with a cross-sectional area larger than that defined by the inner perimeter 136 may be inserted into the opening 126 so that the object contacts and flexes at least one of the plurality of tabs 130 to place the at least one tab 130 in the flexed configuration. Where the object contacts and flexes multiple tabs 130, each of the tabs 130 may flex independently so that each tab 130 can flex at different times and to a different extent. Once the object has passed through, or been removed from the opening 126, the tabs 130 will move back to resume the non-flexed configuration or state. Such movement may occur due to the resilient nature of the material of tabs 130 (e.g., the material of the main body 102).

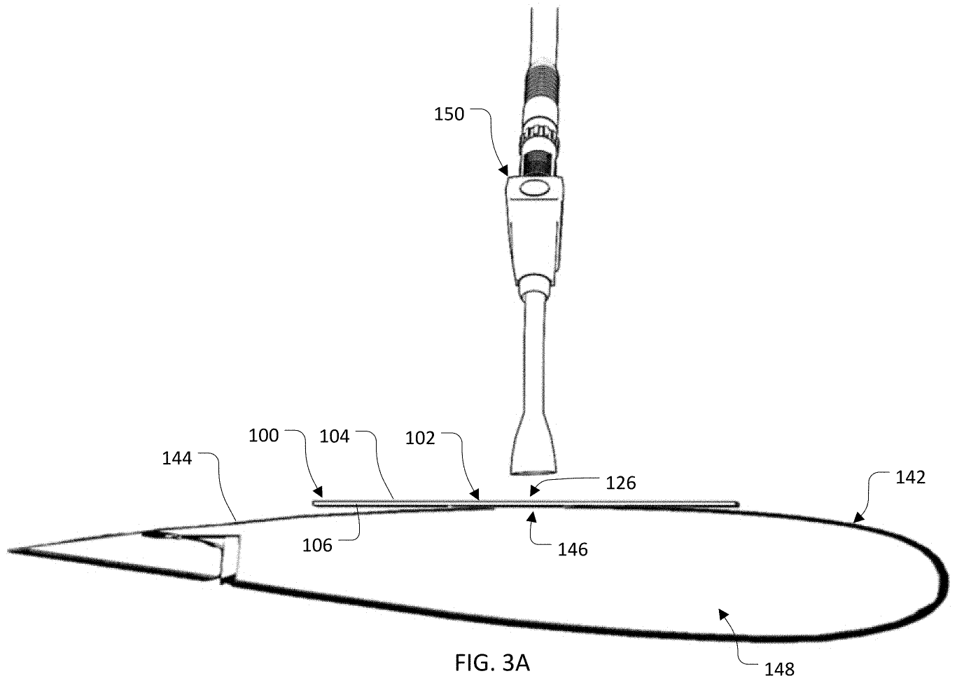

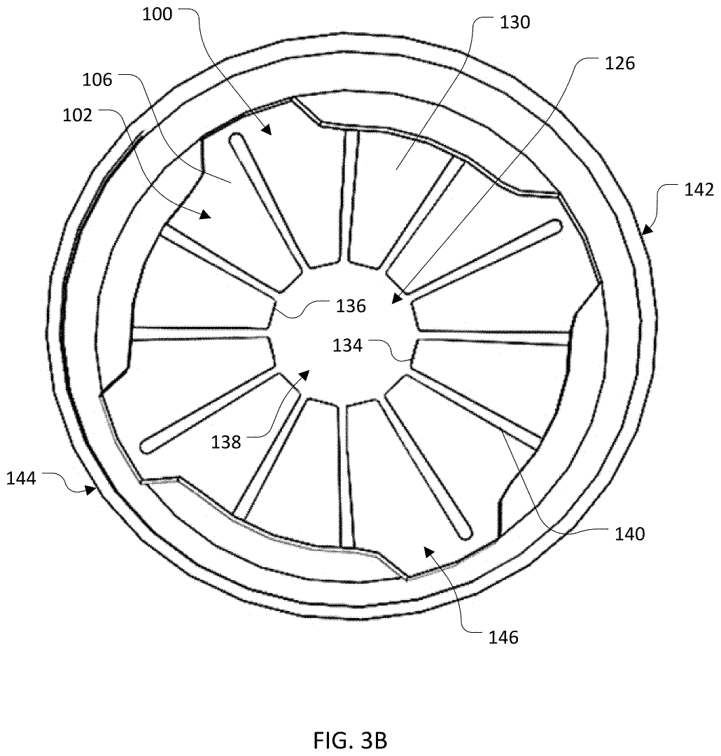

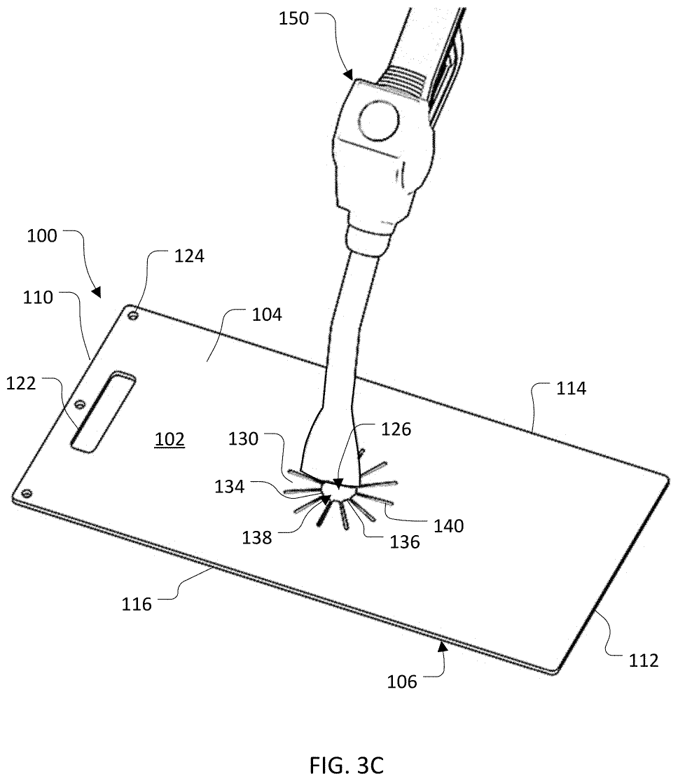

For example, turning to FIGS. 3A-3C, 4A-4C, and 5A-5C, the mat 100 is shown being used to protect a wing 142, and more specifically a wing surface 144, of aircraft during fueling. In particular, the mat 100 is placed onto the wing surface 144 that bottom surface 106 of the main body 102 is in contact with the wing surface. It is appreciated that, while the mat 100 is shown being flat in these schematics, in practice, the main body 102 would bend to conform to the shape of the wing surface 144.

Additionally, the mat 100 is positioned so that the opening 126 is placed over a fuel port 146 that is formed in the wing surface 144 to provide access to an internal fuel tank 148 that is disposed within the wing 142. The fuel port 146 may be normally sealed by a cap (not shown) that can be removed before or after the mat 100 is positioned on the wing surface 144. Furthermore, the wing surface 144 may define a recessed sealing surface (not shown) surrounding the fuel port 146 to allow the cap to create a vapor-tight seal over the fuel port 146, which acts to prevent liquid fuel or fuel vapors from escaping the fuel tank 148 and prevent containments from entering into the fuel tank 148.

The mat 100 is preferably positioned over the fuel port 146 so that the opening is centered over the fuel port 146. In this way, the tabs 130 extend over the fuel port 146, which can help prevent containments or other debris from entering into the fuel tank 148 via the fuel port 146 while the fuel port 146 is open (that is, when the cap is removed).

It is appreciated that many aircraft require visual confirmation to determine when a fuel tank (for example, the fuel tank 148) is full and that such visual confirmation may be at least partially impeded by the tabs 130 extending over the fuel port 146. To improve visibility into the fuel tank, the tabs 130 may be made of a clear material that allows one to see through the tabs 130 and into the fuel tank 148. Alternatively or additionally, the tabs 130 may be spaced further apart to increase the space between the tabs 130 and/or the tabs 130 may be shortened or fractionally eliminated to increase the effective cross-sectional area. However, such changes to the tabs 130 themselves may result in an increased risk of containments from entering the uncovered fuel tank 148. Still further, in the case in which tabs are partially omitted, the protective benefits of the tabs with respect to potential mechanical damage around the port may be reduced since, in that case, the orientation of the existing tabs and the geometry of the nozzle upon insertion will determine to what extent those tabs are able to be protective.

With specific reference to FIGS. 3A-3C, the mat 100 is shown in a pre-fueling configuration where the mat 100 has been positioned on the wing surface 144 as described above. In the pre-fueling configuration, the tabs 130 are in the un-flexed configuration, as a fuel nozzle 150 has not yet been inserted though the opening 126 and the fuel port 146. In this case, the tabs 130 are disposed between the top surface 104 and the bottom surface 106 and are therefore not visible out of the plane of the mat in the side view. However, in other embodiments, for example, with mats that are thinner, made of a more flexible material, and/or that have undergone substantial use, the tabs 130 may extend partially below the bottom surface 106 due to their own weight.

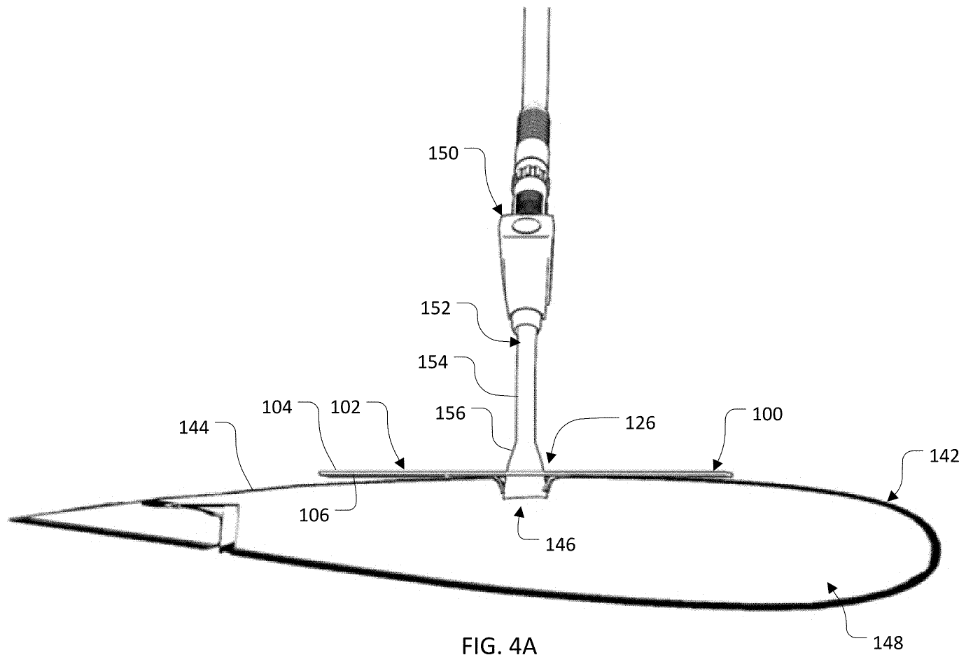

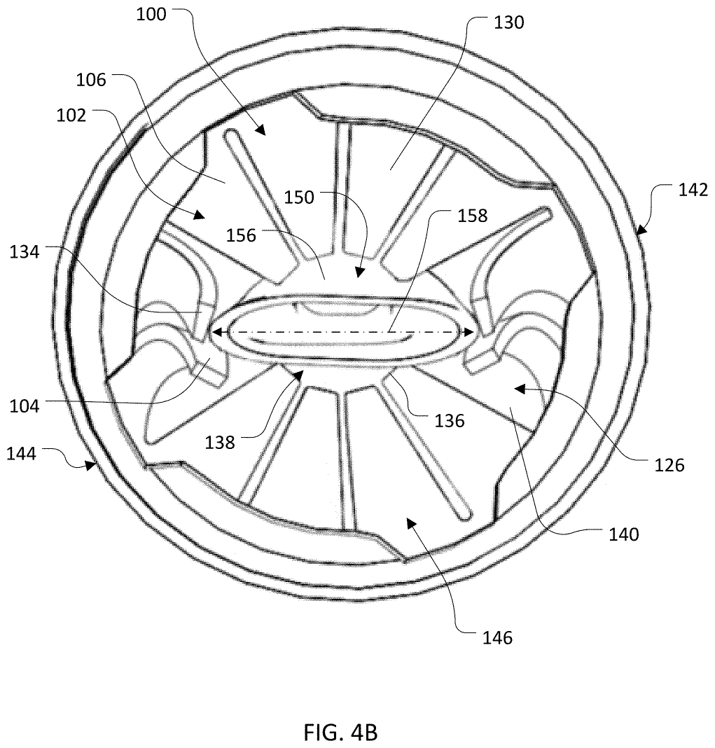

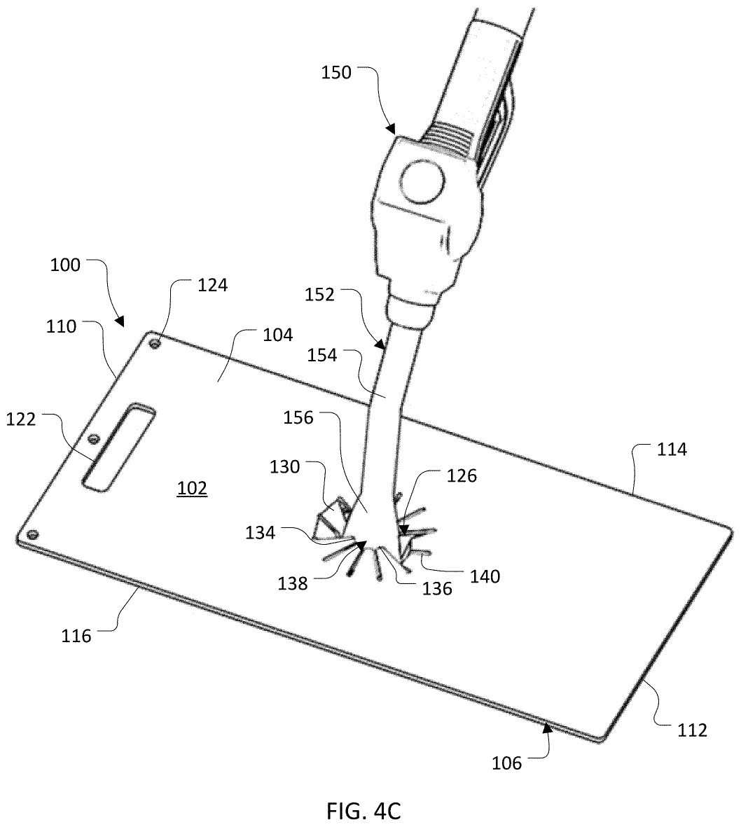

Moving to FIGS. 4A-4C, the mat 100 is shown in a partial-insertion configuration, wherein the fuel nozzle 150 has been partially inserted into the opening 126. More specifically, the fuel nozzle 150 includes a spout 152 having a tubular shaped middle portion 154 with a flared end 156 with a duckbill shape, and the flared end 156 is positioned within the opening 126. The flared end 156 has an oblong cross-section defining a maximum width 158 that is wider than a local width of the inner perimeter 136 of the opening 126. As such, when the flared end 156 is inserted into the opening 126, the flared end 156 contacts a portion of the tabs 130, thereby causing the tabs 130 to assume a flexed configuration where the tabs 130 are flexed downward and beyond the bottom surface 106 of the main body 102 and somewhat outward radially at their tips. In this way, the effective area non-tabbed area of the opening 126 is temporarily increased to allow the flared end 156 to be received within the opening 126.

In some cases, as is shown here, such contact may cause the tabs 130 to be at least partially disposed through the fuel port 146 and into the fuel tank 148, but this may not always be the case. Additionally, as shown, the flared end 156 contacts four of the tabs 130, but in other embodiments more or less tabs 130 may be contacted. For example, because the spout 152 may be sized or shaped differently, and/or the spout 152 may be inserted off-center to one or both of the opening 126 and the fuel port 146.

In the partial-insertion configuration, the tabs 130 remain in contact with flared end 156 of the spout 152 due to the resiliency of the tab material (for example, based on a material of the main body 102). As shown, the tabs 130 may contact the flared end 156 at the respective distal end 134 of the tab 130, and/or along the length of the tab 130. Additionally, the tabs 130 may flex at one or both of the outer perimeter 128 of the opening 126 and along the length of the tab 130. In this way, the tabs 130 are also positioned between the wing surface 144 and the spout 152 to serve as a protective barrier between the spout 152 and the wing surface 144. More specifically, tabs 130 may absorb any impacts to prevent/reduce denting. Similarly, the tabs 130 may prevent the spout 152 from scratching of the wing surface 144, and/or may prevent fuel or other chemicals from spilling onto the wing surface 144. In particular, some mats may include a recess surrounding an outer perimeter of an opening to collect and retain spilled fuel.

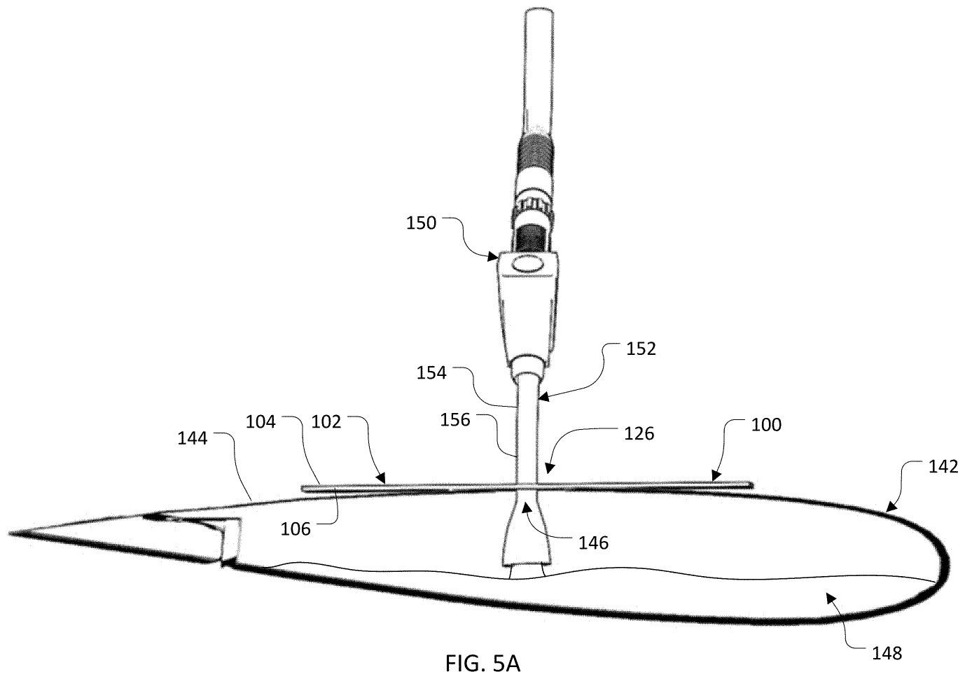

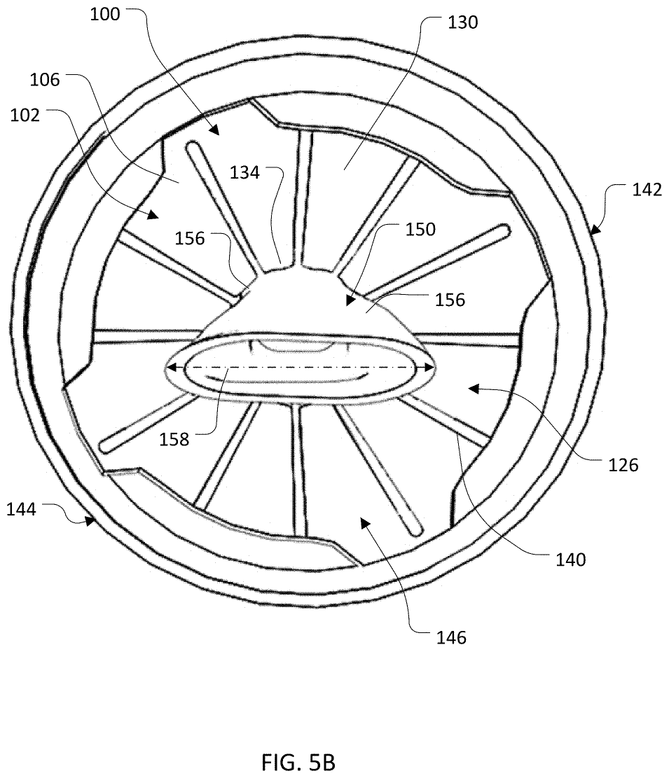

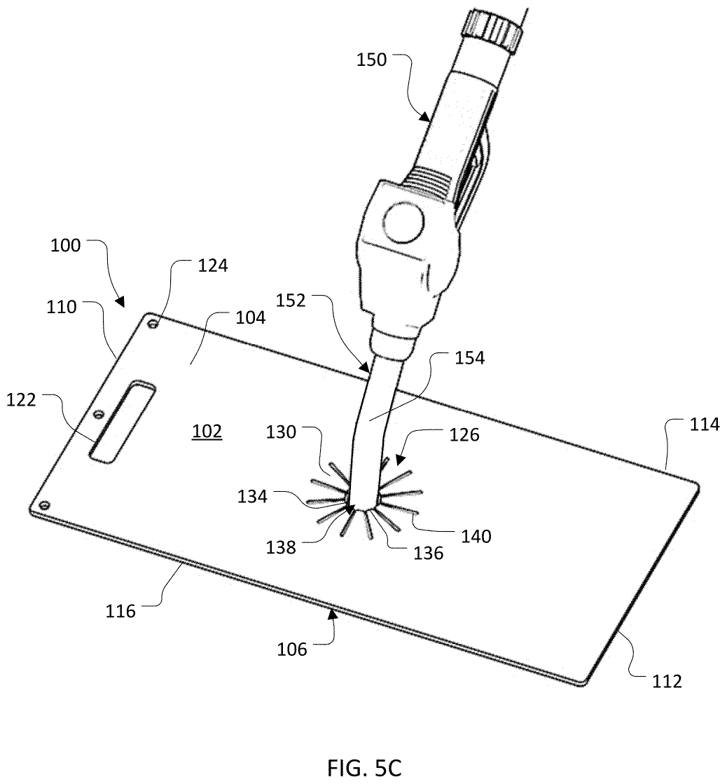

Turning now to FIGS. 5A-5C, the mat 100 is shown in a full-insertion configuration where the spout 152 is further inserted in the opening 126 so that the flared end 156 of the spout 152 is positioned beyond the bottom surface 106 of the main body 102 and the middle portion 154 is disposed within the opening 126. As shown, the middle portion 154 has a width that is smaller than any local width of the inner perimeter of the opening 126. As such, when the middle portion 154 of the spout 152 is centered in the opening 126, the tabs 130 may not contact the middle portion 154 and therefore resume an un-flexed configuration. However, in other embodiments, the middle portion 154 may be larger than the inner perimeter 136 and/or positioned off-center so that some of the tabs 130 remain flexed. Such a scenario may occur where the spout 152 is allowed to rest so that it is directly supported by the top surface 104 of the main body 102 and indirectly by the wing surface 144 during fueling.

Once fueling has been completed, the spout 152 may be removed from the opening 126 and the fuel port 146. During removal, the tabs 130 may flex to allow the flared end 156 to pass through the opening 126, similar to that shown in the partial-insertion configuration shown in FIGS. 4A-4C. However, the tabs 130 may also be flexed in an opposite direction (i.e., in the direction of movement of the spout 152) so that they temporarily flex beyond the top surface 104 of the main body 102. Once the spout 152 has been completely removed, the tabs 130 may resume the un-flexed configuration similar to that shown in the pre-fueling configuration depicted in FIGS. 3A-3C.

It should be appreciated that various other modifications and variations to the preferred embodiments can be made within the spirit and scope of the invention. For example, the spacing, size, orientation, shape, materials, and other features may vary based on application-specific requirements. Therefore, the invention should not be limited to the described embodiments. To ascertain the full scope of the invention, the following claims should be referenced.

What is claimed is:

1. A fueling mat comprising:
a main body configured as a sheet, the main body including:
an opening formed in the main body, the opening defining an outer perimeter; and
a plurality of tabs extending inwardly from the outer perimeter of the opening and configured to flex out of the opening.

2. The fueling mat of claim 1, wherein the plurality of tabs are integrally formed with the main body.

3. The fueling mat of claim 1, wherein the main body has a top surface and a bottom surface, and the opening extends between the top surface and the bottom surface.

4. The fueling mat of claim 1, wherein the plurality of tabs is defined by a corresponding plurality of slots.

5. The fueling mat of claim 1, wherein the outer perimeter of the opening has a round shape and the plurality of tabs extend radially inward from the outer perimeter.

6. The fueling mat of claim 5, wherein each of the plurality of tabs is configured to flex axially and independently out of the opening.

7. The fueling mat of claim 1, wherein the opening further defines an inner perimeter and the tabs extend from the outer perimeter to the inner perimeter.

8. The fueling mat of claim 7, wherein the plurality of tabs flexes to allow an object having a perimeter that is larger than the inner perimeter of the opening, but smaller than the outer perimeter of the opening, to pass through the opening.

9. An equipment servicing mat for protecting a piece of equipment, the equipment servicing mat comprising:
a main body configured as a sheet; and
an opening formed in the main body, the opening including a plurality of outwardly extending slots that define a corresponding plurality of tabs, each of the plurality of tabs configured to independently flex out of the opening.

10. The equipment servicing mat of claim 9, wherein the main body defines a top surface opposite a bottom surface, the bottom surface configured to contact the piece of equipment.

11. The equipment servicing mat of claim 9, wherein the opening is configured to surround a hole in the piece of equipment and at least one of the plurality of tabs is flexible toward the hole.

12. The equipment servicing mat of claim 11, wherein the at least one of the plurality of tabs flexes so that the at least one of the plurality of tabs is at least partially disposed within the hole when flexed.

13. The equipment servicing mat of claim 9, wherein the opening has an inner perimeter having a round shape and the plurality of slots extends radially outward from the inner perimeter.

14. A fueling mat for use in fueling an aircraft in which the aircraft includes a fuel port configured to receive a fuel nozzle, the fueling mat comprising:
a main body configured as a sheet having a top surface opposite a bottom surface, the bottom surface configured to contact the aircraft during fueling;
an opening extending between the top surface and the bottom surface, and the opening defining an outer perimeter; and
a plurality of tabs extending inwardly from the outer perimeter of the opening and configured to flex beyond the bottom surface.

15. The fueling mat of claim 14, wherein, during fueling, the main body is placed over the fuel port so that the outer perimeter of the opening surrounds the fuel port to allow the fuel nozzle to be inserted to both of the opening and the fuel port.

16. The fueling mat of claim 15, wherein the nozzle contacts at least one of the plurality of tabs to flex the at least one of the plurality of tabs beyond the bottom surface and at least partially into the fuel port, the at least one of the plurality of tabs being disposed between the nozzle and the aircraft to protect the aircraft.

17. The fueling mat of claim 16, wherein the at least one of the plurality of tabs extending into the fuel port includes contacting an outer periphery of the fuel port.

18. The fueling mat of claim 14, wherein the opening has a round outer perimeter and the plurality of tabs extend radially inward from the outer perimeter.

19. The fueling mat of claim 14, wherein the main body is made of a flexible material to allow the main body to conform to the shape of the aircraft, and
wherein the plurality of tabs are integrally formed with the main body.

20. A method of using the fueling mat of claim 14, the method including the steps of:
placing the mat on a surface of the aircraft so that the opening surrounds the fuel port; and
inserting the fuel nozzle through the opening and the fuel port so that the fuel nozzle contacts at least one of the plurality of tabs and causes the at least one of the plurality of tabs to flex beyond the bottom surface, the at least one of the plurality of tabs being disposed between the nozzle and the aircraft to protect the aircraft.
